(19) United States
(12) Patent Application Publication
(10) Pub. No.: US 2022/0329556 A1
(43) Pub. Date: Oct. 13, 2022

(54) DETECT AND ALERT USER WHEN SENDING MESSAGE TO INCORRECT RECIPIENT OR SENDING INAPPROPRIATE CONTENT TO A RECIPIENT

(71) Applicant: Avaya Management L.P., Durham, NC (US)

(72) Inventors: Navin Daga, Silapathar (IN); Sandesh Chopdekar, Pune (IN); Pushkar Yashavant Deole, Pune (IN)

(21) Appl. No.: 17/229,445

(22) Filed: Apr. 13, 2021

(51) Int. Cl. H04L 12/58; G06N 20/00

(52) U.S. Cl. CPC H04L 51/14; H04L 51/046; H04L 51/02; H04L 51/30; H04L 51/34; G06N 20/00

(57) ABSTRACT

A device may analyze the content of a communication input via the device and verify a recipient associated with the communication based on the analysis. A machine learning network associated with the device may analyze the content and generate a probability score and a confidence score indicating an association between the communication and the recipient. Based on the probability score or confidence score provided by the machine learning network, the device may verify whether the content of the communication matches profile information associated with the recipient. In some cases, the device may refrain from transmitting the message to the recipient or output a notification suggesting a different recipient for the message. The device may output a notification to modify content of the communication, modify recipients for the communication, select a different messaging window for the communication, or select a different application for the communication.

### FIELD

The present disclosure relates to communication methods and specifically to alerting a user based on content of a message and an intended recipient of the message.

### BACKGROUND

Some devices may support various communication modalities, for example, using messaging applications or social networking applications. In some cases, messaging applications and social networking applications may support any combination of text or multimedia communications between a user and one or more recipients.

### BRIEF SUMMARY

According to example aspects of the present disclosure, techniques are described for analyzing the content of a communication (e.g., a message, a social media posting) input via a device and verifying a recipient associated with the communication based on the analysis. In some aspects, a machine learning network may analyze the content and generate an output (e.g., a probability score and a confidence score) indicative of an association between the communication and the recipient. In an example, based on the output provided by the machine learning network, the device may verify whether the content of the communication matches profile information associated with the recipient (e.g., verify whether the content is appropriate for the recipient).

In an example case, the device may determine that the content does not match the profile information associated with the recipient, and the device may perform one or more operations for corrective action (e.g., modifying content of the communication, modifying recipients for the communication, selecting a different messaging window for the communication, selecting a different application for the communication). For example, the device may output a notification to alert a sender that the recipient may be incorrect (e.g., the content is not associated with the recipient, the content is not suitable for the recipient), and the device may refrain from completing the communication. For example, the device may determine that a recipient for a message is incorrect, and the device may refrain from transmitting the message to the recipient and/or output a notification suggesting a different recipient for the message.

In another example, the device may determine that a recipient tagged for a social media posting is incorrect, and the device may refrain from uploading the social media posting. In some examples, the device may output a notification suggesting to un-tag the recipient and/or tag a different recipient before completing the social media posting. In some other aspects, the device may output a notification suggesting to modify the content (e.g., text, videos, images) before completing the social media posting.

In some aspects, the device may alert the sender that a communication modality (e.g., a messaging window, a messaging application, a social media application) associated with a communication may be incorrect, and the device may output a notification suggesting or indicating that the communication be sent via a different communication modality. For example, the device may identify that content entered into a messaging window associated with a recipient may be intended for a conversation associated with a different messaging window (e.g., a different recipient). The device may refrain from sending the communication via the messaging window via which the communication was entered, and the device may output a notification suggesting or indicating that the content be entered and sent via the different messaging window (e.g., for the different recipient).

In one aspect, a method is provided that includes: identifying a message that is input via a user interface of a device; providing at least a portion of the message to a machine learning network; receiving an output from the machine learning network in response to the machine learning network processing at least the portion of the message, where the output includes: a set of recipients for the message, probability information corresponding to the message and the set of recipients, confidence information associated with the probability information, or a combination thereof; and outputting a notification associated with the message, transmitting the message to a respective device associated with one or more recipients of the set of recipients, or both based on the output from the machine learning network.

Examples may include one of the following features, or any combination thereof.

In an example, the set of recipients includes one or more intended recipients associated with the message, one or more additional recipients different from the one or more intended recipients, or both.

In some examples, the method may include verifying the one or more intended recipients based on the output received from the machine learning network, where outputting the notification, transmitting the message, or both is based on the verification.

In some aspects, the method may include selecting the one or more additional recipients based on the output received from the machine learning network, where outputting the notification, transmitting the message, or both is based on the selection of the one or more additional recipients.

In some examples, the probability information, the confidence information, or both is determined based on a comparison of at least the portion of the message to profile information of one or more contacts associated with the user profile.

In some aspects, the method may include assigning category information to the one or more contacts associated with the user profile, where at least the portion of the message is compared to the profile information of the one or more contacts based on the category information.

In some examples, the method may include extracting contextual information associated with content included in at least the portion of the message, where at least the portion of the message is compared to the profile information of the one or more contacts based on the contextual information. In an example, the one or more contacts includes at least the set of recipients.

In some aspects, the probability information corresponding to the message includes first probability information associated with a first messaging window via which the message is input, second probability information associated with a second messaging window, or both; and the method further includes: selecting the first messaging window or the second messaging window based on the first probability information, the second probability information, or both, where the message is transmitted using the first messaging window or the second messaging window based on the selection.

In some aspects, the probability information corresponding to the message includes first probability information associated with a first application via which the message is input, second probability information associated with a second application, or both; and the method further includes: selecting the first application or the second application based on the first probability information, the second probability information, or both, where the message is transmitted using the first application or the second application based on the selection.

In some aspects, the probability information includes a set of probability scores respectively corresponding to the set of recipients; and the confidence information includes a set of confidence scores respectively corresponding to the set of probability scores; where outputting the notification, transmitting the message, or both is based on a comparison of the set of probability scores to a probability threshold, a comparison of the set of confidence scores to a threshold, or both.

In some examples, the method includes training the machine learning network based on a communication history associated with a user profile, where the output provided by the machine learning network is based on the training.

In some examples, the method includes training the machine learning network based on a set of actions associated with a user profile, where the output provided by the machine learning network is based on the training. In some aspects, the set of actions are associated with one or more previous messages provided to the machine learning network, one or more previous outputs received from the machine learning network, one or more previously output notifications, one or more previously transmitted messages, or a combination thereof.

In some aspects, the message includes text, multimedia data, or both.

In another aspect, a device is provided that includes: a processor; and memory in electronic communication with the processor; and instructions stored in the memory, the instructions being executable by the processor to: identify a message that is input via a user interface of the device; provide at least a portion of the message to a machine learning network; receive an output from the machine learning network in response to the machine learning network processing at least the portion of the message, where the output includes: a set of recipients for the message, probability information corresponding to the message and the set of recipients, confidence information associated with the probability information, or a combination thereof; and output, via the user interface of the device, a notification associated with the message, transmit the message to a respective device associated with one or more recipients of the set of recipients, or both based on the output received from the machine learning network.

In another aspect, an apparatus is provided that includes: means for identifying a message that is input via a user interface of the apparatus; means for providing at least a portion of the message to a machine learning network; means for receiving an output from the machine learning network in response to the machine learning network processing at least the portion of the message, where the output includes: a set of recipients for the message, probability information corresponding to the message and the set of recipients, confidence information associated with the probability information, or a combination thereof; means for outputting a notification associated with the message, transmitting the message to a respective device associated with one or more recipients of the set of recipients, or both based on the output received from the machine learning network.

These and other needs are addressed by the various embodiments and configurations of the present disclosure. The present disclosure can provide a number of advantages depending on the particular configuration. These and other advantages will be apparent from the disclosure contained herein.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid-state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “analyze,” “process,” “execute,” “manage,” “calculate,” and “compute,” and variations thereof, as used herein, are used interchangeably and include any type of methodology, process, mathematical operation or technique. The term “manage” includes any one or more of the terms determine, recommend, configure, organize, show (e.g., display), hide, update, revise, edit, and delete, and includes other means of implementing actions (including variations thereof).

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 illustrates an example of a system that supports detecting and alerting a user when sending a message to an incorrect recipient or sending inappropriate content to a recipient in accordance with aspects of the present disclosure.

FIG. 2 illustrates an example of a system that supports detecting and alerting a user when sending a message to an incorrect recipient or sending inappropriate content to a recipient in accordance with aspects of the present disclosure.

FIG. 3 illustrates an example of a messaging window that supports detecting and alerting a user when sending a message to an incorrect recipient or sending inappropriate content to a recipient in accordance with aspects of the present disclosure.

FIG. 4 illustrates an example of a window that supports detecting and alerting a user when sending a message to an incorrect recipient or sending inappropriate content to a recipient in accordance with aspects of the present disclosure.

FIG. 5 illustrates an example of a process flow that supports detecting and alerting a user when sending a message to an incorrect recipient or sending inappropriate content to a recipient in accordance with aspects of the present disclosure.

FIG. 6 illustrates an example of a process flow that supports detecting and alerting a user when sending a message to an incorrect recipient or sending inappropriate content to a recipient in accordance with aspects of the present disclosure.

FIG. 7 illustrates an example of a process flow that supports detecting and alerting a user when sending a message to an incorrect recipient or sending inappropriate content to a recipient in accordance with aspects of the present disclosure.

### DETAILED DESCRIPTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides illustrative embodiments only, and is not intended to limit the scope or applicability of the disclosure. Furthermore, to avoid unnecessarily obscuring the present disclosure, the preceding description omits a number of known structures and devices. This omission is not to be construed as a limitation of the scopes of the claims. Rather, the ensuing description of the illustrative embodiments will provide those skilled in the art with an enabling description for implementing an illustrative embodiment. It should however be appreciated that the present disclosure may be practiced in a variety of ways beyond the specific detail set forth herein.

Some electronic devices (e.g., smartphones, personal computing devices) may support various communication modalities, for example, using messaging applications or social networking applications on the devices. In some examples, the messaging applications and social networking applications may support text and multimedia communications between a user and one or more recipients. In some cases, a user may send a message to a recipient via a messaging application or a social media application, but may later realize that the message was sent to the wrong recipient(s). For example, the user may inadvertently send a message to a group of people when the user intended to send the message to a single individual. In some cases, the user may inadvertently forward a message to the wrong recipient. In some cases, a user may upload a social media posting, but may later realize that the wrong contact(s) were tagged in the social media posting. Such situations may lead to embarrassment, for example, in a professional conversation on an instant messaging application (e.g., Slack, Skype, etc.), conference, email, etc., a personal conversation over social media, email, conference, etc., and/or during an online teaching session.

For example, when creating and sending a message via a messaging application (e.g., text messaging, instant messaging, e-mail) on a device, the user may accidentally enter recipient information which differs from that of an intended recipient. In another example, a user may be involved in multiple communications with different recipients via different messaging windows of the same application (or different applications). The user may intend to send content (e.g., text, video, audio) to a recipient via a messaging window associated with the recipient, but may inadvertently input and send the content via a different messaging window associated with a different recipient(s). In some other cases, when creating and uploading a social media posting via a social media application on a device, a user may intend to post content (e.g., text, video, audio) and tag another user (e.g., link the other user, notify the other user), but may inadvertently tag an additional user(s).

Such examples may have negative impacts, for example, if the content in a message or social media is offensive to a recipient. For example, the content may be intended for a friend but may be inappropriate for a family member (e.g., some jokes may be unsuitable if sent to a parent). In addition, some messages intended for friends, for example, may be embarrassing if sent to office colleagues. In some other examples, the content in a message intended for a professional contact may include confidential information (e.g., related to business matters, financial matters, financial queries, medical records, etc.), and sending the message to an incorrect recipient (e.g., a contact having a similar name) may expose the confidential information.

Some techniques may support analysis of syntactic content of a message (e.g., an email communication) to identify syntactical errors associated with the message. Some other techniques may support analysis of syntactic content of a message to determine whether an attachment is to accompany the message prior to transmission. However, such techniques do not support detection and analysis of content in a message, such as contextual information with respect to a recipient.

According to example aspects of the present disclosure, techniques are described for analyzing the content of a communication (e.g., a message, a social media message, a social media posting) input or created via a communication device and verifying a recipient associated with the communication based on the analysis.

In an example with respect to social media, the techniques may include building a profile of contacts and type of messages exchanged with the contacts (e.g., based on communication histories). The techniques may include detecting content of media, such as audio (e.g., voice) and video. For example, for a message of a given type (e.g., Message Type A), profile information for a Contact A may indicate that, for a message Type-A, a message sub-type A1 is appropriate (e.g., based on content, for example, contextual information) to send to Contact A, a message sub-type A2 is appropriate to send to Contact A, and a message sub-type A3 is not appropriate to send to Contact A. In some examples, if communication histories (e.g., past data) between a user and a contact are unavailable, aspects of the disclosure may include broadly classifying one or more contacts according to categories (e.g., personal, professional, etc.) and/or using generic data about appropriate messages (e.g., based on content) for each category. Accordingly, once a communication history is established and analyzed, if a device detects that a user is attempting to send or forward a message which does not match a determined profile or classification associated with a contact, the device may alert the user based on the confidence level, thresholds (e.g., detection thresholds, probability thresholds, confidence thresholds), and/or user configuration.

In an example with respect to messaging applications (e.g., conference chats, group instant messaging, email), the techniques described herein may be applied to messages, prior to the messages being sent. For example, a device may analyze a message (e.g., using a text analyzer), prior to sending the message, to determine or verify whether the message is for the intended recipient. For example, the device may determine whether the recipient associated with the message is correct. If the device detects a possibility of an incorrect recipient (e.g., based on a probability score and/or a confidence score), the device may output a notification to alert the user of the same.

In some aspects, the device may refer to a detection threshold when detecting the possibility of an incorrect recipient. In some examples, the device may refer to a detection threshold when outputting the notification to alert the user. In some aspects, based on configured settings, the device may perform different actions based on the confidence level of the detection.

The device may refer to various criteria when determining if a message is being sent to the correct recipient. In an example, if multiple messaging windows are open and the device determines (e.g., based on message content) that an analyzed message is for a discussion on another message window, the device may alert the user of the same. In some examples, the device may check or verify if the text in a message (e.g., intended message) implies that the message is being sent to a single user or multiple users. For example, a message including text such as “This looks good to me, what do you think” or “Are you getting where is he leading to” may imply that the message is being sent to a single user. If the device analyzes the text and detects that the message is addressed to (e.g., being sent to) multiple users, the device may notify the user of the discrepancy.

In some aspects, for message input in a conference or group chat window (e.g., via an instant messaging application), the device may detect that the language of the message is different from the language of the ongoing conference. The device may notify the user that the message is not for all users in the conference or group chat window. In some examples, the device may detect whether a message contains a targeted name. Based on detecting the targeted name, the device may notify the user that the message is for a specific recipient associated with the targeted name. In some other examples, the device may detect that a message would be inappropriate for a large number of people (e.g., due to slang, vulgar language, and/or a comment which may be offensive across races, religions etc.), and the device may notify the user of the same. In some other examples, in an online teaching environment, the device may determine (e.g., check) and/or verify whether a message is for a teacher, co-students, a specific student, and/or a co-teacher. Based on the determination and/or verification, the device may notify the user of the same.

The device may support forward learning based on training data. For example, the device may support forward learning based on past actions of the user (e.g., in response to past notifications provided by the device). In some aspects, the device may improve the accuracy associated with message analysis and/or notifications provided by the device. In some aspects, the device may support a combination of artificial intelligence (e.g., machine learning) and natural language processing for determining whether a message is being sent to the correct recipient. In some other aspects, the device may apply artificial intelligence (e.g., machine learning) and natural language processing in determining whether a message (e.g., an intended message) matches conversations associated with a recipient (e.g., an intended recipient) for the message. In some cases, the device may support the detection of content and/or contextual information from multimedia data (e.g., video, images, audio, etc.) included with a message to be sent. In some aspects, the device may support data models that are tunable according to user parameters (e.g., user requirements) associated with different users, different enterprise applications, etc.

Various additional details of embodiments of the present disclosure will be described below with reference to the figures. While the flowcharts will be discussed and illustrated in relation to a particular sequence of events, it should be appreciated that changes, additions, and omissions to this sequence can occur without materially affecting the operation of the disclosed embodiments, configuration, and aspects.

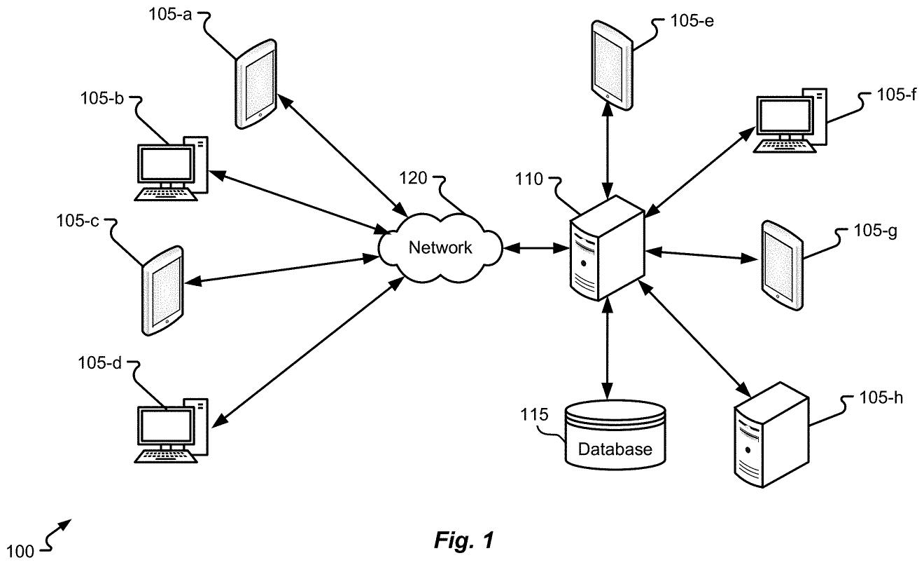

FIG. 1 illustrates an example of a system 100 that supports detecting and alerting a user when sending a message to an incorrect recipient or sending inappropriate content to a recipient in accordance with aspects of the present disclosure.

The system 100 may include communication devices 105 (e.g., communication device 105-a through communication device 105-h), a server 110, a database 115, and a communication network 120. The communication network 120 may facilitate machine-to-machine communications between any of the communication device 105 (or multiple communication devices 105), the server 110, or one or more databases (e.g., database 115). The communication network 120 may include any type of known communication medium or collection of communication media and may use any type of protocols to transport messages between endpoints. The communication network 120 may include wired communications technologies, wireless communications technologies, or any combination thereof.

A communication device 105 may transmit or receive data packets to one or more other devices (e.g., another communication device 105, the server 110) via the communication network 120 and/or via the server 110. For example, the communication device 105-a may communicate (e.g., exchange data packets) with the communication device 105-b via the communications network 120. In another example, the communication device 105-a may communicate with another device (e.g., communication device 105-e, database 115) via the communications network 120 and the server 110.

Non-limiting examples of the communication devices 105 may include, for example, personal computing devices or mobile computing devices (e.g., laptop computers, mobile phones, smart phones, smart devices, wearable devices, tablets, etc.). In some examples, the communication devices 105 may be operable by or carried by a human user. In some aspects, the communication devices 105 may perform one or more operations autonomously or in combination with an input by the user.

The Internet is an example of the communication network 120 that constitutes an Internet Protocol (IP) network consisting of multiple computers, computing networks, and other communication devices located in multiple locations, and components in the communication network 120 (e.g., computers, computing networks, communication devices) may be connected through one or more telephone systems and other means. Other examples of the communication network 120 may include, without limitation, a standard Plain Old Telephone System (POTS), an Integrated Services Digital Network (ISDN), the Public Switched Telephone Network (PSTN), a Local Area Network (LAN), a Wide Area Network (WAN), a wireless LAN (WLAN), a Session Initiation Protocol (SIP) network, a Voice over Internet Protocol (VoIP) network, a cellular network, and any other type of packet-switched or circuit-switched network known in the art. In some cases, the communication network 120 may include of any combination of networks or network types. In some aspects, the communication network 120 may include any combination of communication mediums such as coaxial cable, copper cable/wire, fiber-optic cable, or antennas for communicating data (e.g., transmitting/receiving data).

According to example aspects of the present disclosure, techniques are described for analyzing the content of a communication (e.g., a message, a social media posting) input or created via a communication device 105 and verifying a recipient associated with the communication based on the analysis. In some aspects, a machine learning network (e.g., a machine learning network included in the communication device 105, a machine learning network included in the server 110) may analyze the content and generate an output indicative of an association between the communication and the recipient. The output may include, for example, a probability score and/or a confidence score. In an example, based on the output provided by the machine learning network, the communication device 105 may verify whether the content of the communication matches profile information associated with the recipient. For example, the communication device 105 may verify whether the content matches the profile information based on contextual information with respect to the recipient.

In an example case, the communication device 105 may determine that the content does not match the profile information associated with the recipient, and the communication device 105 may perform one or more operations for corrective action (e.g., modifying content of the communication, modifying recipients for the communication, selecting a different messaging window for the communication, selecting a different application for the communication). For example, the communication device 105 may output a notification to alert a sender that the recipient may be incorrect (e.g., the content is not associated with the recipient, the content is not suitable for the recipient), and the communication device 105 may refrain from completing the communication. For example, the communication device 105 may determine that a recipient for a message is incorrect, and the communication device 105 may refrain from transmitting the message to the recipient. In some aspects, the communication device 105 may output a notification suggesting a different recipient for the message. In some other aspects, the communication device 105 may output a notification suggesting to modify the content of the message.

In another example, the communication device 105 may determine that a recipient tagged for a social media posting is incorrect, and the communication device 105 may refrain from uploading the social media posting. In some aspects, the communication device 105 may output a notification suggesting to un-tag the recipient and/or tag a different recipient before completing the social media posting. In some other aspects, the communication device 105 may output a notification suggesting to modify the content (e.g., text, videos, images) before completing the social media posting.

In some aspects, the communication device 105 may alert the sender that a communication modality (e.g., a messaging window, a messaging application, a social media application) associated with a communication may be incorrect. In an example, the communication device 105 may output a notification suggesting or indicating that the communication be sent via a different communication modality (e.g., a different messaging window, a different messaging application, a different social media application). For example, the communication device 105 may identify that content entered into a messaging window associated with a recipient may be intended for a conversation associated with a different messaging window (e.g., a different recipient). The communication device 105 may refrain from sending the communication via the messaging window via which the communication was entered, and the communication device 105 may output a notification suggesting or indicating that the content be entered via the different messaging window (e.g., for the different recipient).

According to example aspects of the present disclosure, the communication device 105 may identify a message that is input via a user interface of the communication device 105. In some aspects, the message may include text, multimedia data, or both. The communication device 105 may provide at least a portion of the message to a machine learning network (e.g., a machine learning network included in or implemented by the communication device 105 or the server 110). In an example, the communication device 105 may receive an output from the machine learning network in response to the machine learning network processing at least the portion of the message. In some examples, the output may include a set of recipients for the message, probability information corresponding to the message and the set of recipients, confidence information associated with the probability information, or a combination thereof. In some aspects, the probability information may include a set of probability scores respectively corresponding to the set of recipients, and the confidence information may include a set of confidence scores respectively corresponding to the set of probability scores.

The set of recipients may include, for example, one or more intended recipients associated with the message, one or more additional recipients different from the one or more intended recipients, or both. In some examples, the communication device 105 may verify the one or more intended recipients based on the output received from the machine learning network. In some aspects, the communication device 105 may select the one or more additional recipients based on the output received from the machine learning network.

In an example, the communication device 105 may output, via the user interface of the communication device 105, a notification associated with the message, transmit the message to a respective communication device 105 associated with one or more recipients of the set of recipients, or both based on the output received from the machine learning network. In some aspects, outputting the notification, transmitting the message, or both may be based on a comparison of the set of probability scores to a probability threshold, a comparison of the set of confidence scores to a threshold, or both. In some cases, the communication device 105 may output the notification, transmit the message, or both based on the verification of the one or more intended recipients. In some cases, the communication device 105 may output the notification, transmit the message, or both based on the selection of one or more additional recipients.

In some examples, the probability information, the confidence information, or both may be determined (e.g., by the machine learning network) based on a comparison of at least the portion of the message to profile information of one or more contacts associated with the user profile. In some aspects, the communication device 105 may assign category information to the one or more contacts associated with the user profile, where at least the portion of the message is compared (e.g., by the machine learning network) to the profile information of the one or more contacts based on the category information.

In some examples, the communication device 105 may extract contextual information associated with content included in at least the portion of the message, where at least the portion of the message is compared (e.g., by the machine learning network) to the profile information of the one or more contacts based on the contextual information. In an example, the one or more contacts may include at least the set of recipients.

In some aspects, the probability information corresponding to the message may include first probability information associated with a first messaging window via which the message is input, second probability information associated with a second messaging window, or both. In an example, the communication device 105 may select the first messaging window or the second messaging window based on the first probability information, the second probability information, or both, and the communication device 105 may transmit the message using the first messaging window or the second messaging window based on the selection.

Alternatively, or additionally, the probability information corresponding to the message may include first probability information associated with a first application via which the message is input, second probability information associated with a second application, or both. In an example, the communication device 105 may select the first application or the second application based on the first probability information, the second probability information, or both, and the communication device 105 may transmit the message using the first application or the second application based on the selection.

In some examples, the communication device 105 (or server 110) may train the machine learning network based on a communication history associated with a user profile, and the machine learning network may provide the output based on the training. In some examples, the communication device 105 (or server 110) may train the machine learning network based on a set of actions associated with a user profile, and the machine learning network may provide the output based on the training. In some aspects, the set of actions may be associated with one or more previous messages provided by the communication device 105 (or the server 110) to the machine learning network, one or more previous outputs received by the communication device 105 (or server 110) from the machine learning network, one or more previously output notifications by the communication device 105 (or another communication device 105), one or more previously transmitted messages by the communication device 105 (or another communication device 105), or a combination thereof.

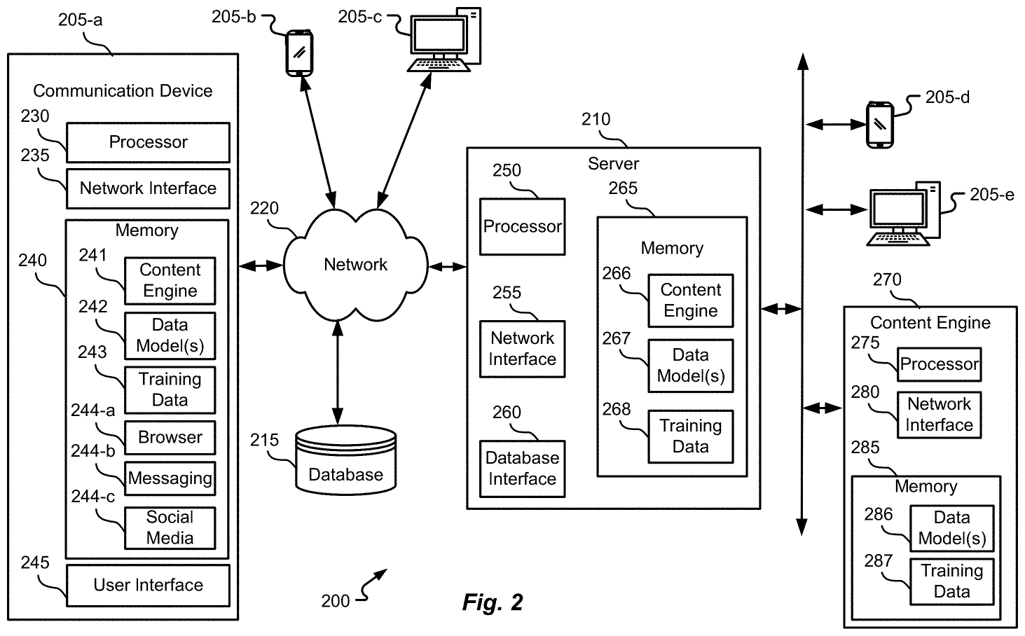

Example aspects of components and functionalities of the communication devices 105, the server 110, the database 115, and the communication network 120 are provided with reference to FIG. 2.

While the illustrative aspects, embodiments, and/or configurations illustrated herein show the various components of the system 100 collocated, certain components of the system 100 can be located remotely, at distant portions of a distributed network, such as a Local Area Network (LAN) and/or the Internet, or within a dedicated system. Thus, it should be appreciated, that the components of the system 100 can be combined in to one or more devices or collocated on a particular node of a distributed network, such as an analog and/or digital telecommunications network, a packet-switched network, or a circuit-switched network. It will be appreciated from the following description, and for reasons of computational efficiency, that the components of the system can be arranged at any location within a distributed network of components without affecting the operation of the system.

FIG. 2 illustrates an example of a system 200 that supports detecting and alerting a user when sending a message to an incorrect recipient or sending inappropriate content to a recipient in accordance with aspects of the present disclosure. In some examples, the system 200 may be implemented by aspects of the system 100 described with reference to FIG. 1. The system 200 may include communication devices 205 (e.g., communication device 205-a through communication device 205-e), a server 210, a database 215, a communication network 220, and a content engine 270. The communication devices 205, the server 210, the database 215, and the communications network 220 may be implemented, for example, by aspects of the communication devices 105, the server 110, the database 115, and the communications network 220 described with reference to FIG. 1.

The communication network 220 may facilitate machine-to-machine communications between any of the communication device 205 (or multiple communication devices 205), the server 210, one or more databases (e.g., database 215), and the content engine 270. The communication network 220 may include any type of known communication medium or collection of communication media and may use any type of protocols to transport messages between endpoints. In some aspects, the communication network 220 may include wired communications technologies, wireless communications technologies, or any combination thereof. In an example, the communication devices 205, the server 210, and the content engine 270 may support communications over the communications network 220 between multiple entities (e.g., users, such as a sender and a recipient). In some cases, the system 200 may include any number of communication devices 205, and each of the communication devices 205 may be associated with a respective entity.

In various aspects, settings of the any of the communication device 205, the server 110, or the content engine 270 may be configured and modified by any user and/or administrator of the system 200. Settings may include thresholds described herein, as well as settings related to how content is managed. Settings may be configured to be personalized for one or more communication devices 205, users of the communication devices 205, and/or other groups of entities, and may be referred to herein as profile settings, user settings, or organization settings. In some aspects, rules and settings may be used in addition to, or instead of, thresholds described herein. In some examples, the rules and/or settings may be personalized by a user and/or administrator for any variable, threshold, user (user profile), communication device 205, entity, or groups thereof.

A communication device 205 (e.g., communication device 205-a) may include a processor 230, a network interface 235, a memory 240, and a user interface 245. In some examples, components of the communication device 205 (e.g., processor 230, network interface 235, memory 240, user interface 245) may communicate over a system bus (e.g., control busses, address busses, data busses) included in the communication device 205. In some cases, the communication device 205 may be referred to as a computing resource.

In some cases, the communication device 205 (e.g., communication device 205-a) may transmit or receive packets to one or more other devices (e.g., another communication device 205, the server 210, the database 215, the content engine 270) via the communication network 220, using the network interface 235. The network interface 235 may include, for example, any combination of network interface cards (NICs), network ports, associated drivers, or the like. Communications between components (e.g., processor 230, memory 240) of the communication device 205 and one or more other devices (e.g., another communication device 205, the database 215, the content engine 270) connected to the communication network 220 may, for example, flow through the network interface 235.

The processor 230 may correspond to one or many computer processing devices. For example, the processor 230 may include a silicon chip, such as a Field Programmable Gate Array (FPGA), an Application-Specific Integrated Circuit (ASIC), any other type of Integrated Circuit (IC) chip, a collection of IC chips, or the like. In some aspects, the processors may include a microprocessor, a Central Processing Unit (CPU), a Graphics Processing Unit (GPU), or plurality of microprocessors configured to execute the instructions sets stored in a corresponding memory (e.g., memory 240 of the communication device 205). For example, upon executing the instruction sets stored in memory 240, the processor 230 may enable or perform one or more functions of the communication device 205.

The processor 230 may utilize data stored in the memory 240 as a neural network. The neural network may include a machine learning architecture. In some aspects, the neural network may be or include an artificial neural network (ANN). In some other aspects, the neural network may be or include any machine learning network such as, for example, a deep learning network, a convolutional neural network, or the like. Some elements stored in memory 240 may be described as or referred to as instructions or instruction sets, and some functions of the communication device 205 may be implemented using machine learning techniques.

The memory 240 may include one or multiple computer memory devices. The memory 240 may include, for example, Random Access Memory (RAM) devices, Read Only Memory (ROM) devices, flash memory devices, magnetic disk storage media, optical storage media, solid-state storage devices, core memory, buffer memory devices, combinations thereof, and the like. The memory 240, in some examples, may correspond to a computer-readable storage media. In some aspects, the memory 240 may be internal or external to the communication device 205.

The memory 240 may be configured to store instruction sets, neural networks, and other data structures (e.g., depicted herein) in addition to temporarily storing data for the processor 230 to execute various types of routines or functions. For example, the memory 240 may be configured to store program instructions (instruction sets) that are executable by the processor 230 and provide functionality of a content engine 241 described herein. The memory 240 may also be configured to store data or information that is useable or capable of being called by the instructions stored in memory 240. One example of data that may be stored in memory 240 for use by components thereof is a data model(s) 242 (also referred to herein as a neural network model) and/or training data 243 (also referred to herein as a training data and feedback).

The content engine 241 may include a single or multiple engines. The communication device 205 (e.g., the content engine 241) may utilize one or more data models 242 for recognizing and processing information obtained from other communication devices 205, the server 210, and the database 215. In some aspects, the communication device 205 (e.g., the content engine 241) may update one or more data models 242 based on learned information included in the training data 243. In some aspects, the content engine 241 and the data models 242 may support forward learning based on the training data 243. The content engine 241 may have access to and use one or more data models 242. For example, the data model(s) 242 may be built and updated by the content engine 241 based on the training data 243. The data model(s) 242 may be provided in any number of formats or forms. Non-limiting examples of the data model(s) 242 include Decision Trees, Support Vector Machines (SVMs), Nearest Neighbor, and/or Bayesian classifiers.

In some examples, the training data 243 may include communication inputs such as communication information associated with the communication device 205. In some cases, the communication information may include communication histories between the communication device 205 and other communication devices 205 (e.g., any of communication device 205-b through communication device 105-e), real-time communication data between the communication device 205 and other communication devices 205, data transmissions between the communication device 205 and the server 210, etc. In some aspects, communication histories between a communication device 205 (e.g., communication device 205-a) and another communication device 205 (e.g., communication device 205-b) may include communication between a user of the communication device 205 and a user of the other communication device 205.

The content engine 241 may be configured to analyze content, which may be any type of information, including information that is historical or in real-time. The content engine 241 may be configured to receive information from other communication devices 205 and/or the server 210. The content engine 241 may be configured to analyze profile information associated with one or more users, groups, etc. The profile information can include any type of information, including audio and visual information. The content engine 241 may build any number of user profiles using automatic processing, using artificial intelligence and/or using input from one or more users associated with the communication devices 205. The content engine 241 may use automatic processing, artificial intelligence, and/or inputs from one or more users of the communication devices 205 to determine, manage, and/or combine information relevant to a user profile.

The content engine 241 may determine user profile information based on a user's interactions with information. The content engine 241 may update (e.g., continuously, periodically) user profiles based on new information that is relevant to the user profiles. The content engine 241 may receive new information from any communication device 205, the server 210, the database 215, etc. Profile information may be organized and classified in various manners. In some aspects, the organization and classification of profile information may be determined by automatic processing, by artificial intelligence and/or by one or more users of the communication devices 205.

The content engine 241 may create, select, and execute appropriate processing decisions. Processing decisions may include content management, content extraction, and content analysis associated with communications (e.g., messages, social media posts) created by a communication device 205. Illustrative examples of content management include rearranging content, modifying content, changing formatting of content, and showing and/or hiding content. Processing decisions, including content analysis, may be handled automatically by the content engine 305, with or without human input.

The content engine 241 may store, in the memory 240 (e.g., in a database included in the memory 240), historical information (e.g., communication histories) between the communication device 205 and other devices (e.g., other communication devices 205, the server 210, etc.). Data within the database of the memory 240 may be updated, revised, edited, or deleted by the content engine 241. In some aspects, the content engine 241 may support continuous, periodic, and/or batch fetching of content (e.g., content referenced within a communication, content related to a user, content related to a recipient, etc.) and content aggregation.

Information stored in the database included in the memory 240 may include and is not limited to communication information, user information, historical analysis information, processing information including historical processing information, key words, configurations, settings, variables, and properties. Further, information regarding the relevance of different types of content, as well as how to determine relevance (e.g., rules, settings, source(s) of content, rankings of content, location of key words/phrases, repetition of key words/phrases, definitions of relevance, etc.) or contextual information associated with content may be stored in the database included in the memory 240.

The communication device 205 may render a presentation (e.g., visually, audibly, using haptic feedback, etc.) of an application 244 (e.g., a browser application 244-a, a messaging application 244-b, a social media application 244-c). In an example, the communication device 205 may render the presentation via the user interface 245. The user interface 245 may include, for example, a display (e.g., a touchscreen display), an audio output device (e.g., a speaker, a headphone connector), or any combination thereof. In some aspects, the applications 244 may be stored on the memory 240. In some cases, the applications 244 may include cloud-based applications or server-based applications (e.g., supported and/or hosted by the server 210). Settings of the user interface 245 may be partially or entirely customizable and may be managed by one or more users, by automatic processing, and/or by artificial intelligence.

In an example, any of the applications 244 (e.g., browser application 244-a, messaging application 244-b, social media application 244-c) may be configured to receive data in an electronic format and present content of data via the user interface 245. For example, the applications 244 may receive data from another communication device 205, the server 210, or the content engine 270 via the communications network 220, and the communication device 205 may display the content via the user interface 245.

The database 215 may include a relational database, a centralized database, a distributed database, an operational database, a hierarchical database, a network database, an object-oriented database, a graph database, a NoSQL (non-relational) database, etc. In some aspects, the database 215 may store and provide access to, for example, any of the stored data described herein.

The server 210 may include a processor 250, a network interface 255, database interface instructions 260, and a memory 265. In some examples, components of the server 210 (e.g., processor 250, network interface 255, database interface 260, memory 265) may communicate over a system bus (e.g., control busses, address busses, data busses) included in the server 210. The processor 250, network interface 255, and memory 265 of the server 210 may include examples of aspects of the processor 230, network interface 235, and memory 240 of the communication device 205 described herein.

For example, the processor 250 may be configured to execute instruction sets stored in memory 265, upon which the processor 250 may enable or perform one or more functions of the server 210. In some aspects, the processor 250 may utilize data stored in the memory 265 as a neural network. In some examples, the server 210 may transmit or receive packets to one or more other devices (e.g., a communication device 205, the database 215, another server 210, the content engine 270) via the communication network 220, using the network interface 255. Communications between components (e.g., processor 250, memory 265) of the server 210 and one or more other devices (e.g., a communication device 205, the database 215, the content engine 270) connected to the communication network 220 may, for example, flow through the network interface 255.

In some examples, the database interface instructions 260 (also referred to herein as database interface 260), when executed by the processor 250, may enable the server 210 to send data to and receive data from the database 215. For example, the database interface instructions 260, when executed by the processor 250, may enable the server 210 to generate database queries, provide one or more interfaces for system administrators to define database queries, transmit database queries to one or more databases (e.g., database 215), receive responses to database queries, access data associated with the database queries, and format responses received from the databases for processing by other components of the server 210.

The memory 265 may be configured to store instruction sets, neural networks, and other data structures (e.g., depicted herein) in addition to temporarily storing data for the processor 250 to execute various types of routines or functions. For example, the memory 265 may be configured to store program instructions (instruction sets) that are executable by the processor 250 and provide functionality of the content engine 266 described herein. One example of data that may be stored in memory 265 for use by components thereof is a data model(s) 267 (also referred to herein as a neural network model) and/or training data 268. The data model(s) 267 and the training data 268 may include examples of aspects of the data model(s) 242 and the training data 243 described with reference to the communication device 205. For example, the server 210 (e.g., the content engine 266) may utilize one or more data models 267 for recognizing and processing information obtained from communication devices 205, another server 210, and the database 215. In some aspects, the server 210 (e.g., the content engine 266) may update one or more data models 267 based on learned information included in the training data 268.

In some aspects, components of the content engine 266 may be provided in a separate engine (e.g., the content engine 270) in communication with the server 210. In an example, the content engine 270 may include a processor 275, a network interface 280, and a memory 285. In some examples, components of the content engine 270 (e.g., processor 275, network interface 280, memory 285) may communicate over a system bus (e.g., control busses, address busses, data busses) included in the content engine 270. The processor 275, network interface 280, memory 285 may include examples of aspects of the processor 250, network interface 255, and memory 265 of the server 210 described herein.

For example, the memory 285 may be configured to store program instructions (instruction sets) that are executable by the processor 275 and provide functionality of the content engine 270 described herein. One example of data that may be stored in memory 285 for use by components thereof is a data model(s) 286 (also referred to herein as a neural network model) and/or training data 287. The data model(s) 286 and the training data 287 may include examples of aspects of the data model(s) 267 and the training data 268 described with reference to the content engine 266.

According to example aspects of the present disclosure, a communication device 205 (e.g., communication device 205-a) may support one or more operations or procedures associated with analyzing the content of a communication (e.g., a message, a social media posting) via the communication device 205. For example, the communication device 205 may identify a communication input by a user (also referred to herein as a sender) of the communication device 205, via the messaging application 244-b or the social media application 244-c. In some cases, the messaging application 244-b may include a text messaging application, an instant messaging application, an electronic messaging board application, an email application, or the like. The communication may be a message including text and/or multimedia data (e.g., video, images, audio, etc.). The message may include a recipient (also referred to herein as an intended recipient or an addressee) or a set of recipients associated with the message.

In some cases, the social media application 244-c may be a standalone messaging application associated with a social media client, a social media application for monitoring and/or posting social media updates, or the like. The communication may be a message or social media posting including text and/or multimedia data (e.g., video, images, audio, etc.). In an example of a message communicated via a messaging application associated with the social media client, the message may include a recipient (also referred to herein as an intended recipient or an addressee) or a set of recipients associated with the communication. In an example of a social media posting via a social media application, the social media posting may include a contact “tagged” in the social media posting. Examples of the aspects described herein may be applied to messages communicated via the messaging application 244-b or the social media application 244-c, social media posts created and published via the social media application 244-c, or the like.

In an example, the recipient(s) may be a recipient selected by the communication device 205 (e.g., based on a user input, autonomously by the communication device 205) from a contact list associated with a user profile of the user. In some aspects, the contact list may be stored in the memory 240 of the communication device 205, the memory 265 of the server 210, the database 215, the content engine 270, and/or any cloud-based storage. The contact list may include profile information (e.g., image-based, text-based, etc.) associated with contacts included in the contact list.

The communication device 205 may provide at least a portion of the message to a machine learning network (e.g., a machine learning network implemented by the content engine 241, the content engine 266, or the content engine 270) to confirm the recipient, for example, prior to sending the message. In an example, the communication device 205 may provide the message (or message portion) to the machine learning network based on receiving a user input (e.g., via the user interface 245) for sending the message. Alternatively, or additionally, the communication device 205 may provide portions of the message in real-time, for example, as the message is input to the communication device 205.

In an example, the machine learning network may generate an output based on an analysis of the content of the message (or message portion). For example, the machine learning network may analyze the content of the message to determine whether the message is for the recipient. The machine learning network may extract and analyze contextual information associated with the message, for example, to determine whether the message is for the recipient. In an example, the machine learning network may determine the contextual information from text (e.g., language used, text strings, etc.) included with the message.

For example, the machine learning network may determine the contextual information using natural language processing techniques such as linguistic context recognition, word recognition, etc. In some aspects, the machine learning network may support text scanning, searching, parsing, and/or analysis (including performing semantic and/or syntactic analysis). In an example, the machine learning network may support recognition of key words (e.g., names) associated with the contextual information. In some examples, the machine learning network may divide and/or subdivide text content into portions based on paragraphs, sentences, sections, types of content, etc.

In some aspects, the machine learning network may determine the contextual information from multimedia data (e.g., video, images, audio, etc.) included with the message (or portion of the message). For example, the machine learning network may determine the contextual information using techniques such as object detection and recognition (e.g., facial detection and recognition, landmark detection and recognition, etc.) to video images or still images. In some examples, the machine learning network may apply techniques such as audio-based context recognition to audio data associated with the video images. In some other cases, the machine learning network may apply audio-based context recognition to audio data (e.g., an audio file, a voice recording) included with the message.

In an example of analyzing the content, the machine learning network (e.g., implemented by the content engine 241, the content engine 266, or the content engine 270) may compare the contextual information to profile information associated with the recipient. In an example, the recipient may be included in a contact list associated with the sender of the message. In some cases, based on the comparison, the machine learning network may determine a strength of a relationship, also referred to herein as a relevancy or a contextual relationship, between the content of the message (e.g., contextual information, subject matter) and the recipient (e.g., addressee) indicated in the message. In some aspects, the strength of the relationship may be indicated by probability information (e.g., a probability score) and/or confidence information (e.g., a confidence score) described herein.

In an example case, the communication device 205 may determine that the content does not match the profile information associated with the recipient (e.g., based on a relatively low probability score and/or confidence score), and the communication device 205 may perform one or more operations for corrective action (e.g., modifying content of the message, modifying recipients for the message, selecting a different messaging window for the message, selecting a different application for sending the message). For example, the communication device 205 may output a notification to alert a sender that the recipient may be incorrect (e.g., the content is not associated with the recipient, the content is not suitable for the recipient), and the communication device 205 may refrain from completing the communication. For example, the communication device 205 may determine that a recipient for a message is incorrect, and the communication device 205 may refrain from transmitting the message to the recipient. In some aspects, the communication device 205 may output a notification suggesting a different recipient for the message.

In an example, for a message addressed to a recipient, the machine learning network may generate an output inclusive of probability information and confidence information corresponding to the message and the recipient. The probability information, for example, may include a probability score (e.g., from 0.00 to 1.00) of whether the content of the message matches profile information associated with the recipient. The confidence information, for example, may include a confidence score (e.g., from 0.00 to 1.00) corresponding to the probability score.

For example, the recipient may be associated with (e.g., classified with) a group of contacts in the contact list, and the machine learning network may determine the probability score based on a correlation between the content (e.g., context information) of the message and a classification (e.g., close friend, acquaintance, immediate family member, extended family member, professional contact, age group, etc.) associated with the recipient. In some examples, the machine learning network may output a relatively low probability score for cases in which the machine learning network identifies a relatively low correlation (e.g., below a threshold) between the content of the message and the classification associated with the recipient. In some other examples, the machine learning network may output a relatively high probability score for cases in which the machine learning network identifies a relatively high correlation (e.g., above a threshold) between the content of the message and the classification associated with the recipient.

In another example, for a message addressed to multiple recipients, the machine learning network may generate an output inclusive of probability information and confidence information corresponding to the message and any or all of the recipients. For example, the machine learning network may compare the contextual information to respective profile information associated with the recipients. The probability information may include respective probability scores corresponding to any or all of the recipients determined, for example, based on a correlation between the content (e.g., context information) of the message and respective classifications (e.g., close friend, acquaintance, immediate family member, extended family member, professional contact, age group, teacher, student, etc.) associated with the recipients. In some aspects, the confidence information may include respective confidence scores corresponding to the probability scores.

In an example, for a message input via a messaging window associated with a recipient(s), the machine learning network may identify that the content of the message may be inappropriate for family members (e.g., due to slang or vulgar language included in the message, an offensive joke included in the message, sensitive topics such as politics or religion included in the message, etc.). In some examples, the machine learning network may output a relatively low probability score for any recipient(s) classified as a family member or a professional contact (e.g., an office colleague). In some other examples, the machine learning network may output a relatively high probability score for any recipient(s) classified as a close friend or personal contact. In some cases, the machine learning network may determine the probability scores based on an analysis of communication histories (e.g., communications also including slang, vulgar language, sensitive topics, etc.) between the sender of the message and contacts associated with the sender.

In another example, in an online classroom environment, for a message input via a messaging window for a recipient(s), the machine learning network may identify whether content of the message is intended for teachers, co-students, a target student, a target co-teacher, or the like. In an example, for a message input by an assistant teacher, the machine learning network may identify that the content of the message (e.g., confidential student reports) is intended for a lead teacher. The machine learning network may output a relatively low probability score for any recipient(s) classified as students. In some other examples, the machine learning network may output a relatively high probability score for any recipient(s) classified as teachers or co-teachers.

In another example, a message input via a messaging window may be associated with a recipient named “Bill Smith” who is classified as a family contact, and the machine learning network may identify that the content of the message includes confidential personal information (e.g., financial information, a financial query). For example, the message may indicate “Hello, Bill. Attached are my tax returns in connection with my mortgage application.” In some examples, the machine learning network may identify whether the recipient “Bill Smith” is classified as a financial contact. For example, the machine learning network may determine that the recipient “Bill Smith” is not classified as a financial contact, but rather a family contact, and the machine learning network may output a relatively low probability score associated with “Bill Smith.” Alternatively, or additionally, the machine learning network may provide or suggest an alternative recipient for the message. For example, the machine learning network may provide or suggest a recipient “Bill Daily” that is classified as a financial contact, and the machine learning network may output a relatively high probability score associated with “Bill Daily.”

In some other examples, the machine learning network may determine or calculate probability scores and confidence scores corresponding to the message and one or more recipients different from the initial recipient(s) (e.g., addressee(s)) indicated in the message. For example, the machine learning network may identify additional contacts (e.g., different from the initial recipients of the message) included in the contact list of the user and compare the contextual information of the message to respective profile information associated with the additional contacts. In some cases, based on the comparison, the machine learning network may provide or suggest alternative or additional recipients for the message. For example, the machine learning network may provide or output probability scores and confidence scores for initial recipients and/or recipients suggested by the machine learning network.

In an example, for a message (e.g., “Hello, User A. What time are we meeting today?”) input via a messaging window associated with a recipient (e.g., User B), the machine learning network may identify that a targeted name (e.g., User A) included in the content of the message is different from the recipient (e.g., User B) associated with the messaging window. The machine learning network may output a relatively low probability score between the message and the messaging window. In some aspects, the machine learning network may output a relatively high probability score between the message and a different messaging window that is associated with User A.

In another example, for a message input via a messaging window, the machine learning network may generate an output inclusive of probability information and confidence information corresponding to the messaging window. The probability information, for example, may include a probability score (e.g., from 0.00 to 1.00) of whether the content of the message matches the messaging window. The confidence information, for example, may include a confidence score (e.g., from 0.00 to 1.00) corresponding to the probability score.

For example, for a message input via a messaging window associated with a recipient(s), the machine learning network may determine the probability score with respect to the message and the recipient(s) based on a correlation between the content (e.g., context information) of the message and a communication history associated with the messaging window. In an example, the machine learning network may compare the content (e.g., context information) of the message input via the messaging window to the content (e.g., context information) of ongoing or prior communications within the messaging window. In some examples, the machine learning network may output a relatively low probability score for cases in which the machine learning network identifies a relatively low correlation (e.g., below a threshold) between the contextual information associated with the message and the contextual information associated with the communication history associated with the messaging window. In some other examples, the machine learning network may output a relatively high probability score for cases in which the machine learning network identifies a relatively high correlation (e.g., above a threshold) between the contextual information associated with the message and the contextual information associated with the communication history for the messaging window.

In an example, for a message input via a group messaging window associated with multiple recipients (e.g., a conference, a group chat), the machine learning network may identify that the content (e.g., contextual information) of the message is different from the content (e.g., contextual information) of ongoing or prior communications within the group messaging window. For example, based on the content, the machine learning network may identify or detect that the message is not intended for all users within the group messaging window, and the machine learning network may output a relatively low probability score between the message and the group messaging window.

Alternatively, or additionally, if the user is involved in multiple communications with different recipients via different messaging windows of the same application (or across different applications), the machine learning network may determine a probability score (e.g., from 0.00 to 1.00) and associated confidence score (e.g., from 0.00 to 1.00) of whether the content (e.g., contextual information) of the message matches the content (e.g., contextual information) associated with a communication history for a different messaging window. For example, the machine learning network may determine the probability score and/or confidence sore based on a correlation between the content (e.g., context information) of the message and a communication history associated with the different messaging window.

In another example, for a message input via a messaging window associated with a quantity of recipients (e.g., one, multiple), the machine learning network may determine a probability score and/or confidence score based on a correlation between the content (e.g., context information) of the message and the quantity of recipients associated with the messaging window. For example, for cases in which the machine learning network identifies that the contextual information of a message input via a messaging window implies a different quantity of recipients (e.g., a single recipient) compared to the quantity of recipients associated with the messaging window (e.g., multiple recipients), the machine learning network may output a relatively low probability score. In some examples, for cases in which the machine learning network identifies that the contextual information of a message input via a messaging window implies a same quantity of recipients compared to the quantity of recipients associated with the messaging window, the machine learning network may output a relatively high probability score.

In an example, a message input via a messaging window may include message text such as “This looks good to me, what do you think” or “Are you getting where is he leading to.” The machine learning network may determine that the contextual information associated with the message text implies that the message is intended for a single recipient. For a case in which the messaging window is associated with a multiple recipients, the machine learning network may output a relatively low probability score. For a case in which the messaging window is associated with a single recipient, the machine learning network may output a relatively high probability score.

In other examples, for a message input via an application (e.g., messaging application 244-b, social media application 244-c), the machine learning network may generate an output inclusive of probability information and confidence information corresponding to the message and the application. The probability information, for example, may include a probability score (e.g., from 0.00 to 1.00) of whether the content of the message matches the application. The confidence information, for example, may include a confidence score (e.g., from 0.00 to 1.00) corresponding to the probability score. For example, the machine learning network may determine the probability score and/or confidence sore based on a correlation between the content (e.g., context information) of the message and a communication history associated with the application.

Based on the output (e.g., analysis, probability scores, confidence scores) generated by the machine learning network with respect to a message, the communication device 205 may output a notification associated with the message. For example, the communication device 205 may verify a recipient (e.g., intended recipient) associated with the message. In some aspects, the communication device 205 may suggest one or more other recipients (e.g., alternative or additional recipients) for the message. The communication device 205 may render or output one or more notifications for verifying a recipient and/or suggesting other recipients. In some aspects, the communication device 205 may transmit the message to a respective device associated with a recipient (e.g., intended recipient) and/or one or more additional recipients.

For example, the communication device 205 may output a notification verifying a recipient (e.g., an intended recipient, an alternative recipient, an additional recipient, etc.) based on a probability score corresponding to the recipient being equal to or greater than a probability score threshold. In an example, the communication device 205 may output the notification verifying the recipient based on a confidence score (corresponding to the probability score) being equal to or greater than a confidence score threshold. In some other aspects, the communication device 205 may output a notification invalidating the recipient based on the probability score being less than the probability score threshold and/or the confidence score being less than the confidence score threshold.

The thresholds described herein may be set based on various criteria, and multiple thresholds may be set or configured for different types of content. In some cases, the thresholds may be pre-set (e.g., previously configured, pre-determined, or determined before the content organizer methods are applied to new content), and may change based on any criteria. For example, the rules and thresholds may be set by a user, automatically, and/or by artificial intelligence before a communication to which content is to be applied is received. In addition, thresholds may be set automatically and changed automatically (for example based on other thresholds), by artificial intelligence, and/or they may be defined by a user.

The machine learning network may determine the probability scores and/or confidence scores associated with a message, a messaging window, a messaging application, and/or a recipient based on a combination of thresholds. In some aspects, each threshold may be associated with a respective weighting factor. For example, when determining contextual information associated with a communication (e.g., a message, a social media posting), the machine learning network may assign a probability score based on a first threshold associated with detecting or identifying a set of key words according to a first criteria (e.g., names included in the message text, names included in a recipient list). The machine learning network may modify (e.g., increase) the probability score based on a second threshold associated with detecting or identifying a set of key words according to a second criteria (e.g., a correlation between the content of the communication and a classification associated with the recipient). The machine learning network may modify (e.g., increase) the probability score based on a third threshold associated with detecting or identifying a set of key words according to a third criteria (e.g., whether the content of the message matches the content associated with a communication history for a messaging window via which the message is input or a different messaging window). The machine learning network may support any combination of criteria, thresholds, and/or weighting factors, and the machine learning network may apply the same in any order when calculating and/or assigning a probability score.

In some other aspects, based on the output (e.g., analysis, probability scores, confidence scores) generated by the machine learning network, the communication device 205 may verify content associated with the message. For example, for message content input via a messaging window or messaging application, the communication device 205 may render or output one or more notifications verifying that the content is appropriate for an intended recipient (e.g., addressee) of the message. In some aspects, the communication device 205 may output a notification verifying the content based on a probability score corresponding to the content being equal to or greater than a probability score threshold. In an example, the communication device 205 may output the notification verifying the content based on a confidence score corresponding to the probability score being equal to or greater than a confidence score threshold. In some other aspects, the communication device 205 may output a notification invalidating the content based on the probability score being less than the probability score threshold and/or the confidence score being less than the confidence score threshold.

In some aspects, the notification may include any combination of visual, audio, and/or haptic notifications via the user interface 245 (e.g., a display) and/or an external device (e.g., wireless headphones, a wearable device such as smart glasses or a smartwatch, etc.) coupled to the communication device 205. In some examples, when outputting notifications associated with a communication (e.g., a message, a social media posting), the communication device 205 may apply visual differences (e.g., different highlighting, different colors, different font types, etc.) to content within the communication and/or filter the content within the communication to show less content (e.g., content having a relevance above a threshold).

In some other aspects, based on the output (e.g., analysis, probability scores, confidence scores) generated by the machine learning network, the communication device 205 may verify a communication modality or communication type associated with the message. For example, multiple messaging windows may be active at the communication device 205, and the communication device 205 may render or output one or more notifications for verifying a messaging window via which a message addressed to a recipient is input. In another example, multiple messaging applications may be active at the communication device 205, and the communication device 205 may render or output one or more notifications for verifying a messaging application via which a message addressed to a recipient is input. Accordingly, for example, for a case in which a user is involved in multiple communications with different recipients via different messaging windows of the same application (or different messaging windows among different applications), the communication device 205 may output one or more notifications for confirming a messaging window via which a message is input. In some aspects, the communication device 205 may output one or more notifications for confirming a messaging application via which a message is input.

In an example, the communication device 105 may alert the sender that a communication modality (e.g., a messaging window, a messaging application, a social media application) associated with a communication may be incorrect. In an example, the communication device 105 may output a notification suggesting or indicating that the communication be sent via a different communication modality (e.g., a different messaging window, a different messaging application, a different social media application). For example, the communication device 105 may identify that content entered into a messaging window associated with a recipient may be intended for a conversation associated with a different messaging window (or different application) associated with a different recipient. The communication device 105 may refrain from sending the communication via the messaging window via which the communication was entered, and the communication device 105 may output a notification suggesting or indicating that the content be entered via the different messaging window (or different application) for the different recipient.

The communication device 205 may transmit the message based on a user input. For example, based on the output notification provided by the communication device 205, the user input may confirm any of a recipient for a message, content of the message, a messaging window for sending the message, and an application for sending the message. The communication device 205 may transmit the message based on the user input. In some cases, the communication device 205 may autonomously transmit the message based on learned information included in training data (e.g., training data 243, training data 268, training data 287). The training data may include, for example, previous actions by a user with respect to probability scores and confidence scores calculated by the machine learning network. The training data may include, for example, previous actions by a user with respect to notifications previously output by the communication device 205. In some examples, the previous actions may include confirming or invalidating a recipient for a message, confirming or invalidating content of the message, confirming or invalidating a messaging window for sending the message, and/or confirming or invalidating an application for sending the message.

Alternatively, or additionally, the communication device 205 may perform one or more operations for modifying the recipient for the message, modifying content of the message, selecting a different messaging window for sending the message, and/or selecting a different application for sending the message. For example, based on the output notification (e.g., probability scores, confidence scores) provided by the communication device 205, the user input may invalidate (e.g., remove or modify) a recipient for the message, modify content of the message, select a different messaging window for sending the message, and/or select a different application for sending the message. In some aspects, the communication device 205 may update data models (e.g., data model 242, data model 267, data model 286) and/or training data (e.g., training data 243, training data 268, training data 287) based on user decisions.

In some aspects, the probability score thresholds and/or confidence score thresholds described herein may be configurable via the communication device 205 (e.g., based on user settings). In some other aspects, the probability score threshold and/or confidence score threshold may autonomously configured by the communication device 205 or a machine learning network described herein. For example, the communication device 205 or machine learning network may autonomously configure the probability score threshold and/or confidence score threshold based on learned information included in training data (e.g., training data 243, training data 268, training data 287). The training data may include, for example, previous decisions by a user (e.g., confirming or invalidating recipients) with respect to predictions by the machine learning network (e.g., suggested recipients, verified recipients, and/or invalidated recipients). In some aspects, the training data may include data communications created, transmitted, or received by the communication device 205 over the communication network 220.

In another example supportive of operations or procedures associated with analyzing the content of a communication (e.g., message, a social media posting) via the communication device 205, the communication device 205 may identify a communication input by a user (also referred to herein as a sender or author) of the communication device 205, via the social media application 244-c. The communication (e.g., message, social media posting) may include text, multimedia data (e.g., video, images, audio, etc.). The communication may include a recipient (or addressee) in the case of a message. The communication may include a “tagged” contact in the case of a social media posting.

In an example, the communication device 205 may determine that a contact “tagged” for a social media posting is incorrect, and the communication device 105 may refrain from completing (e.g., uploading) the social media posting. In some aspects, the communication device 205 may output a notification suggesting to “un-tag” the contact and/or “tag” a different contact before completing the social media posting. In some other aspects, the communication device 205 may output a notification suggesting to modify the content (e.g., text, videos, images) before completing the social media posting.

In some examples, the communication device 205 may output the notification based on a probability score and/or confidence score generated by a machine learning network (e.g., included in or implemented by the content engine 241, the content engine 266, or the content engine 270) described herein. For example, the communication device 205 may output at least a portion of the content associated with the social media posting to the machine learning network. The machine learning network may generate a probability score (e.g., from 0.00 to 1.00) of whether the content of the social media posting matches profile information associated with the “tagged” contact. In some aspects, the machine learning network may generate a confidence score (e.g., from 0.00 to 1.00) corresponding to the probability score.

In some cases, the machine learning network may build the profile information associated with the “tagged” contact based on a communication history (e.g., message content, types of messages) between the “tagged” contact and the user. For example, the machine learning network may build profile information associated with different contacts of the user based on communication histories between the contacts and the user.

In an example, the profile information for a Contact A may indicate that, for a message Type-A, a message sub-type A1 is appropriate (e.g., based on content, for example, contextual information) to send to Contact A, a message sub-type A2 is appropriate to send to Contact A, and a message sub-type A3 is not appropriate to send to Contact A. Alternatively, or additionally, the profile information for Contact A may indicate social media posting types that are appropriate (e.g., based on content) or inappropriate for “tagging” the contact.

As can be appreciated by one skilled in the art, functions offered by the elements depicted herein may be implemented in one or more network devices (e.g., servers 210, networked communication devices 205, non-networked communication devices 205, etc.).

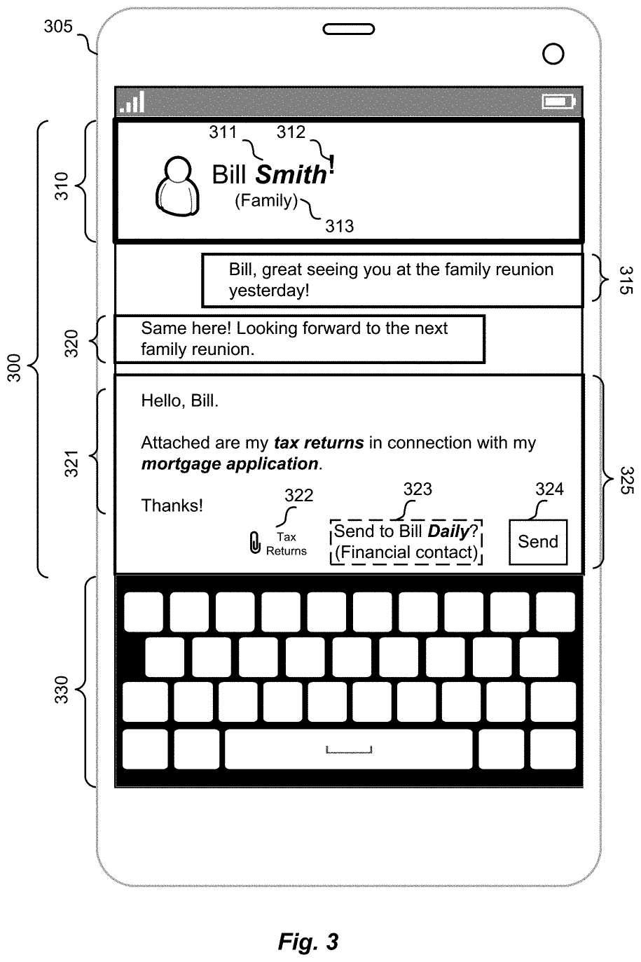

FIG. 3 illustrates an example of a messaging window 300 for a messaging that supports detecting and alerting a user when sending a message to an incorrect recipient or sending inappropriate content to a recipient in accordance with aspects of the present disclosure. FIG. 3 illustrates an example communication device 305, and the messaging window 300 may be an example of a messaging window described herein. The communication device 305 may include examples of aspects of a communication device 105 or a communication device 205 described with reference to FIGS. 1 and 2. The communication device 305 may display a user interface 330 (e.g., an on-screen keyboard) for inputting messages.

The messaging window 300 may include a header 310 indicating a contact (e.g., Bill Smith) associated with the messaging window 300. The header 310 may include the name 311 (e.g., Bill Smith) of the contact and classification information 313 (e.g., family) associated with the contact. The messaging window 300 may include a communication history associated with a user of the communication device 305 and the contact. For example, the communication history may include messages (e.g., message 315) previously sent by the user and messages (e.g., message 320) previously received from the contact.

In an example, the user may have input a message 321 stating, “Hello, Bill. Attached are my tax returns in connection with my mortgage application.” The user may have included an attachment 322 (e.g., “Tax Returns”) to the message 321. A machine learning network (e.g., integrated or implemented by the communication device 305, a server, or content engine described herein) may identify that the content of the message 321 (e.g., contextual information associated with the text “tax returns” and “mortgage application) is associated with confidential financial information. In an example, the machine learning network may identify that the attachment 322 (e.g., based on contextual information associated with the title of the attachment 322, based on content included in the attachment 322) is associated with confidential financial information.

The machine learning network may determine that the recipient “Bill Smith” is not classified as a financial contact, but as a family contact, from stored profile information associated with “Bill Smith.” In some examples, the machine learning network may determine the classification based on the classification information 313 and/or content (e.g., contextual information, for example, “family reunion”) associated with the message 315 or the message 320. The machine learning network may output a relatively low probability score associated with “Bill Smith” and the messaging window 300. Alternatively, or additionally, the machine learning network may output a relatively high probability score associated with an alternative recipient “Bill Daily” that is classified as a financial contact. Based on the probability scores (and associated confidence scores), the communication device 305 output a notification 323 suggesting the alternative recipient, “Bill Daily.” Alternatively, or additionally, the communication device 305 may display a notification 312 alerting the user that the recipient “Bill Smith” may be incorrect. In some aspects, when alerting the user of the incorrect recipient and/or the suggested recipient, the communication device 305 may apply visual differences (e.g., different highlighting, different colors, different font types, etc.) to any portion of the name 311 (e.g., bold italics for “Smith”), the message 321 (e.g., bold italics for “tax returns” and/or “mortgage application”), and/or the notification 323 (e.g., bold italics for “Daily”).

In some aspects, the communication device 305 may output the notification 312, the notification 323, and/or apply visual differences described herein in real-time as the user inputs the message 321 and/or includes the attachment 322. In some other aspects, the communication device 305 may output the notification 312, the notification 323, and/or apply visual differences based on detecting a user input selecting the “send” button 324. In some examples, based on a user input selecting the notification 323, the communication device 305 may move (e.g., cut and paste) the message 321, a text portion of the message 321, and/or the attachment 322 to a different messaging window (e.g., associated with the alternative recipient “Bill Daily”) of the messaging application.

In some other examples, based on the user input selecting the notification 323, the communication device 305 may move (e.g., cut and paste) the text 321 and/or the attachment 322 to a messaging window (e.g., associated with the alternative recipient “Bill Daily”) of a different messaging application. For example, the communication device 305 may move the text 321 and/or attachment 322 to an existing messaging window associated with the user and the alternative recipient “Bill Daily.” In some aspects, the communication device 305 may autonomously move the text 321 and/or attachment 322 based on prior inputs by the user with respect to previous notifications 323 and previously sent messages.

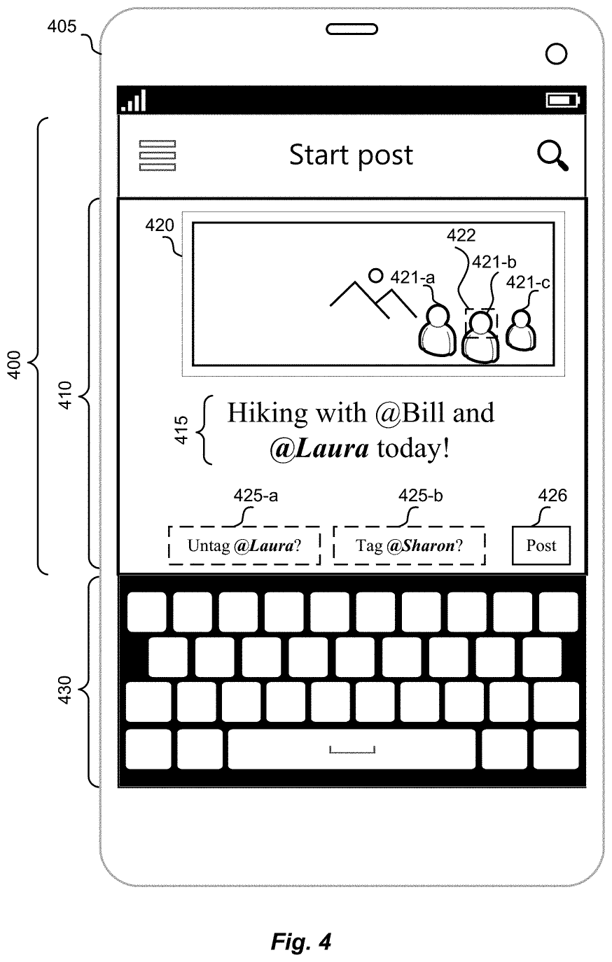

FIG. 4 illustrates an example of a window 400 for social media posting that supports detecting and alerting a user when sending a message to an incorrect recipient or sending inappropriate content to a recipient in accordance with aspects of the present disclosure. FIG. 4 illustrates an example communication device 405, and the window 400 may be an example of a messaging window described herein. The communication device 405 may include examples of aspects of a communication device 105, a communication device 205, or a communication device 305 described with reference to FIGS. 1 through 3. The communication device 405 may display a user interface 430 (e.g., an on-screen keyboard) for inputting messages.

The window 400 may include an input area 410 for social media posting. In an example, the social media posting may include text 415 (e.g., “Hiking with @Bill and @Laura today!”) and multimedia content 420 (e.g., an image or video). In an example, the communication device 405 may determine that a contact “tagged” (e.g., using the “@” symbol) in the social media posting is incorrect based on an analysis of content (e.g., contextual information, such as names) associated with the text 415 and the multimedia content 420. In some examples, based on the determination, the communication device 105 may refrain from completing (e.g., uploading) the social media posting.

For example, a machine learning network (e.g., integrated or implemented by the communication device 405, a server, or content engine described herein) may identify that individuals 421-a through 421-c included in the multimedia content 420 respectively correspond to the user of the communication device 405 (e.g., sender or author of the social media posting), a contact named “Bill,” and a contact named “Sharon.” In an example, the machine learning network may identify facial information of the individuals 421-a through 421-c using, for example, object recognition (e.g., facial recognition). In some aspects, the machine learning network may compare (e.g., cross-reference) the facial information to profile information (e.g., images, profile pictures) of contacts associated with the user of the communication device 405. Based on the comparison, the machine learning network may determine or predict the identities of the individuals 421-a through 421-c.

In an example, the communication device 405 may output a notification 425-a suggesting to “un-tag” a contact (e.g., “Laura”) before completing the social media posting. In some examples, the communication device 405 may output a notification 425-b to “tag” a different contact (e.g., “Sharon”) before completing the social media posting. In some other aspects, the communication device 205 may output a notification suggesting to modify the content (e.g., modify the text 415, modify the multimedia content 420, post different multimedia content 420, etc.) before completing the social media posting. The communication device 405 may “un-tag” the contact “Laura” based on a user input selecting the notification 425-a and/or “tag” the contact “Sharon” based on a user input selecting the notification 425-b. In some examples, the communication device 405 may autonomously “un-tag” the contact “Laura” and/or “tag” the contact “Sharon” based on previous user inputs with respect to previous notifications 425 and previous social media postings.

In some aspects, when alerting the user of the incorrectly tagged contacts, the communication device 405 may apply visual differences (e.g., different highlighting, different colors, different font types, etc.) to any portion of the text 415 (e.g., bold italics for “Laura”), the multimedia content 420, the notification 425-a, or the notification 425-b (e.g., bold italics for “Sharon”). In some examples, the communication device 405 may display a visual indicator 422 associated with an incorrectly tagged contact.

In some aspects, the communication device 405 may output the notification 425-a, the notification 425-b, and/or apply visual differences described herein in real-time as the user inputs the text 415 and/or includes the multimedia content 420. In some other aspects, the communication device 405 may output the notification 425-a, the notification 425-b, and/or apply visual differences based on detecting a user input selecting the “post” button 426.

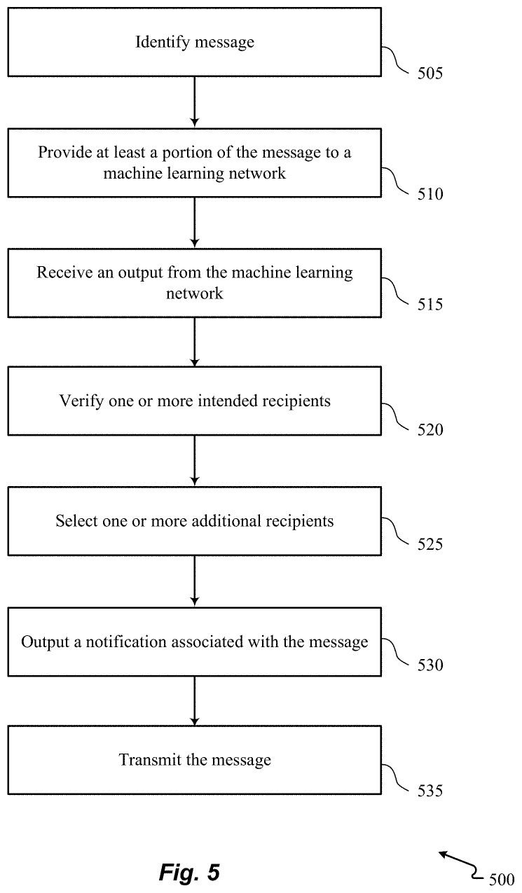

FIG. 5 illustrates an example of a process flow 500 that supports detecting and alerting a user when sending a message to an incorrect recipient or sending inappropriate content to a recipient in accordance with aspects of the present disclosure. In some examples, process flow 500 may implement aspects of a communication device 105, a server 110, a communication device 205, a server 210, or a content engine 270, and a communication device 305 described with reference to FIGS. 1, 2, and 3.

In the following description of the process flow 500, the operations may be performed in a different order than the order shown, or the operations may be performed in different orders or at different times. Certain operations may also be left out of the process flow 500, or other operations may be added to the process flow 500. It is to be understood that while the communication device 105 is described as performing a number of the operations of process flow 500, any device (e.g., another communication device 105, a combination of a communication device 105 and a server 110) may perform the operations shown.

According to example aspects of the present disclosure, at 505, a communication device 105 may identify a message (or a social media posting) that is input via a user interface of the communication device 105. In some aspects, the message may include text, multimedia data, or both.

At 510, the communication device 105 may provide at least a portion of the message to a machine learning network (e.g., a machine learning network included in or implemented by the communication device 105 or the server 110).

At 515, the communication device 105 may receive an output from the machine learning network in response to the machine learning network processing at least the portion of the message. In some examples, the output may include a set of recipients for the message, probability information corresponding to the message and the set of recipients, confidence information associated with the probability information, or a combination thereof. In some aspects, the probability information may include a set of probability scores respectively corresponding to the set of recipients, and the confidence information may include a set of confidence scores respectively corresponding to the set of probability scores.

The set of recipients may include, for example, one or more intended recipients associated with the message, one or more additional recipients different from the one or more intended recipients, or both. In some examples, at 520, the communication device 105 may verify the one or more intended recipients based on the output received from the machine learning network. In some aspects, at 525, the communication device 105 may select the one or more additional recipients based on the output received from the machine learning network.

At 530, the communication device 105 may output, via the user interface of the communication device 105, a notification associated with the message based on the output received from the machine learning network.

Alternatively, or additionally, at 535, the communication device 105 may transmit the message to a respective communication device 105 associated with one or more recipients of the set of recipients, based on the output received from the machine learning network. In some aspects, outputting the notification, transmitting the message, or both may be based on a comparison of the set of probability scores to a probability threshold, a comparison of the set of confidence scores to a threshold, or both. In some cases, the communication device 105 may output the notification, transmit the message, or both based on the verification of the one or more intended recipients. In some cases, the communication device 105 may output the notification, transmit the message, or both based on the selection of one or more additional recipients.

In some examples, the probability information, the confidence information, or both may be determined (e.g., by the machine learning network) based on a comparison of at least the portion of the message to profile information of one or more contacts associated with the user profile. In some aspects, the communication device 105 may assign category information to the one or more contacts associated with the user profile, where at least the portion of the message is compared (e.g., by the machine learning network) to the profile information of the one or more contacts based on the category information.

In some examples, the communication device 105 may extract contextual information associated with content included in at least the portion of the message, where at least the portion of the message is compared (e.g., by the machine learning network) to the profile information of the one or more contacts based on the contextual information. In an example, the one or more contacts may include at least the set of recipients.

In some aspects, the probability information corresponding to the message may include first probability information associated with a first messaging window via which the message is input, second probability information associated with a second messaging window, or both. In an example, the communication device 105 may select the first messaging window or the second messaging window based on the first probability information, the second probability information, or both, and the communication device 105 may transmit the message using the first messaging window or the second messaging window based on the selection.

Alternatively, or additionally, the probability information corresponding to the message may include first probability information associated with a first application via which the message is input, second probability information associated with a second application, or both. In an example, the communication device 105 may select the first application or the second application based on the first probability information, the second probability information, or both, and the communication device 105 may transmit the message using the first application or the second application based on the selection.

In some examples, the communication device 105 (or server 110) may train the machine learning network based on a communication history associated with a user profile, and the machine learning network may provide the output based on the training. In some examples, the communication device 105 (or server 110) may train the machine learning network based on a set of actions associated with a user profile, and the machine learning network may provide the output based on the training. In some aspects, the set of actions may be associated with one or more previous messages provided by the communication device 105 (or the server 110) to the machine learning network, one or more previous outputs received by the communication device 105 (or server 110) from the machine learning network, one or more previously output notifications by the communication device 105 (or another communication device 105), one or more previously transmitted messages by the communication device 105 (or another communication device 105), or a combination thereof.

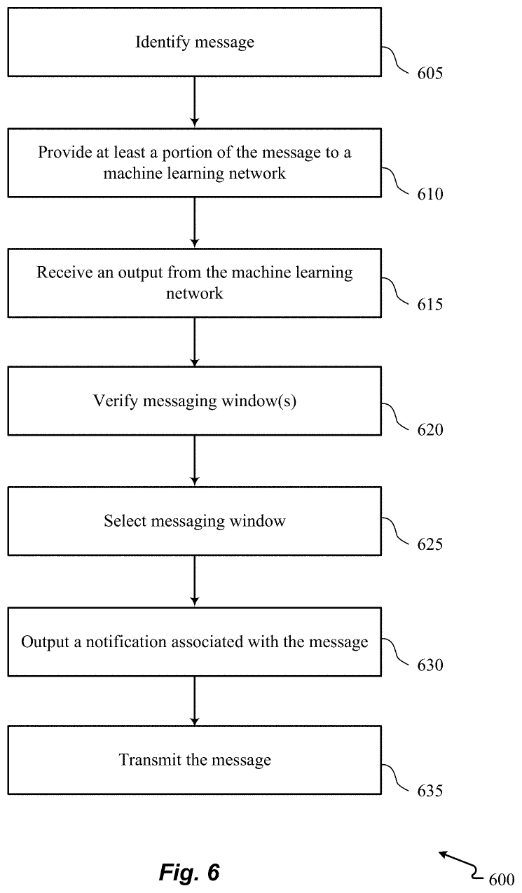

FIG. 6 illustrates an example of a process flow 600 that supports detecting and alerting a user when sending a message to an incorrect recipient or sending inappropriate content to a recipient in accordance with aspects of the present disclosure. In some examples, process flow 600 may implement aspects of a communication device 105, a server 110, a communication device 205, a server 210, or a content engine 270, and a communication device 305 described with reference to FIGS. 1, 2, and 3.

In the following description of the process flow 600, the operations may be performed in a different order than the order shown, or the operations may be performed in different orders or at different times. Certain operations may also be left out of the process flow 600, or other operations may be added to the process flow 600. It is to be understood that while the communication device 105 is described as performing a number of the operations of process flow 600, any device (e.g., another communication device 105, a combination of a communication device 105 and a server 110) may perform the operations shown.

According to example aspects of the present disclosure, at 605, a communication device 105 may identify a message (or a social media posting) that is input via a user interface of the communication device 105. In some aspects, the message may include text, multimedia data, or both.

At 610, the communication device 105 may provide at least a portion of the message to a machine learning network (e.g., a machine learning network included in or implemented by the communication device 105 or the server 110).

At 615, the communication device 105 may receive an output from the machine learning network in response to the machine learning network processing at least the portion of the message. In some aspects, the output from the machine learning network may include first probability information associated with a first messaging window via which the message is input, confidence information associated with the first probability information, second probability information associated with a second messaging window (a different active messaging window via which the user may intend to input the message), confidence information associated with the second probability information, or a combination thereof.

In an example, the machine learning network may identify that the message is input via the first messaging window, and the machine learning network may further identify that the content (e.g., contextual information) of the message corresponds to content (e.g., contextual information) associated with the second messaging window. For example, the machine learning network may identify that the content of the message is similar (e.g., based on a threshold) to content included in the communication history associated with the second messaging window.

In an example, regarding the first and second messaging windows, the output from the machine learning network may indicate a relatively high probability score (e.g., above a threshold) associated with the second messaging window, in combination with a relatively high confidence score (e.g., above a threshold) associated with the probability score. For the first messaging window, the output from the machine learning network may further indicate a relatively low probability score (e.g., below a threshold), in combination with a relatively high confidence score (e.g., above a threshold) associated with the probability score.

At 620, the communication device 105 may verify a messaging window (e.g., the first messaging window and/or the second messaging window) based on the output received from the machine learning network. For example, the communication device 105 may verify whether the message is associated with the first messaging window or the second messaging window.

At 625, the communication device 105 may select a messaging window (e.g., the first messaging window or the second messaging window) based on the first probability information, the second probability information, or both.

At 630, the communication device 105 may output, via the user interface of the communication device 105, a notification associated with the message and the selected messaging window (e.g., the first messaging window, the second messaging window) based on the output received from the machine learning network and/or the selection by the communication device 105.

At 635, the communication device 105 may transmit the message using the first messaging window or the second messaging window based on the selection by the communication device 105. In some aspects, the selection by the communication device 105 may be automatic (e.g., based on training data, forward learning, etc.). In some other aspects, the selection by the communication device 105 may be in combination with a user input.

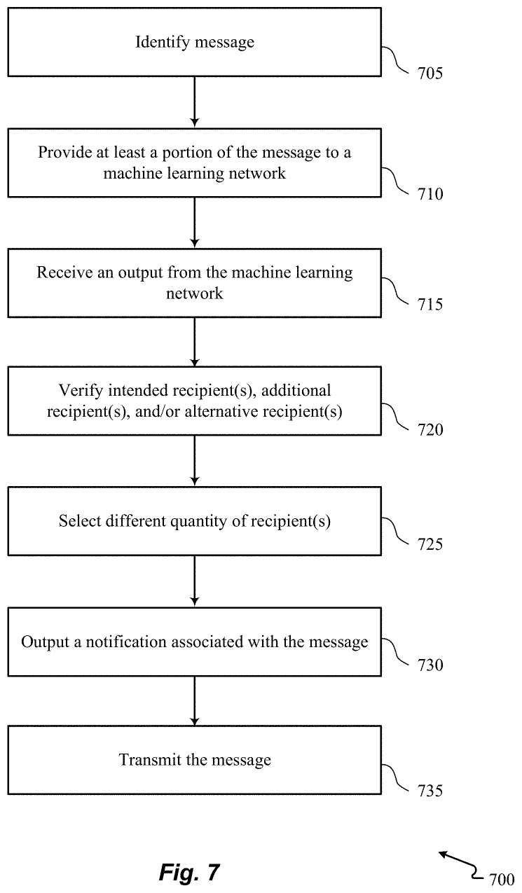

FIG. 7 illustrates an example of a process flow 700 that supports detecting and alerting a user when sending a message to an incorrect recipient or sending inappropriate content to a recipient in accordance with aspects of the present disclosure. In some examples, process flow 700 may implement aspects of a communication device 105, a server 110, a communication device 205, a server 210, or a content engine 270, and a communication device 305 described with reference to FIGS. 1, 2, and 3.

In the following description of the process flow 700, the operations may be performed in a different order than the order shown, or the operations may be performed in different orders or at different times. Certain operations may also be left out of the process flow 700, or other operations may be added to the process flow 700. It is to be understood that while the communication device 105 is described as performing a number of the operations of process flow 700, any device (e.g., another communication device 105, a combination of a communication device 105 and a server 110) may perform the operations shown.

According to example aspects of the present disclosure, at 705, a communication device 105 may identify a message (or a social media posting) that is input via a user interface of the communication device 105. In some aspects, the message may include text, multimedia data, or both.

At 710, the communication device 105 may provide at least a portion of the message to a machine learning network (e.g., a machine learning network included in or implemented by the communication device 105 or the server 110).

At 715, the communication device 105 may receive an output from the machine learning network in response to the machine learning network processing at least the portion of the message. In some examples, the output may include a set of recipients for the message, probability information corresponding to the message and the set of recipients, confidence information associated with the probability information, or a combination thereof. In some aspects, the probability information may include a set of probability scores respectively corresponding to the set of recipients, and the confidence information may include a set of confidence scores respectively corresponding to the set of probability scores.

The set of recipients may include, for example, one or more intended recipients associated with the message (e.g., initial addressees), one or more additional recipients different from the one or more intended recipients (e.g., one or more alternative recipients), a different number of recipients (e.g., lower or higher number of recipients), or a combination thereof.

At 720, the communication device 105 may verify the one or more intended recipients, one or more additional recipients, and/or one or more alternative recipients based on the output received from the machine learning network.

In an example, the machine learning network may identify that the message is addressed to a multiple recipients, and the machine learning network may further identify that the content (e.g., contextual information) of the message suggests a single recipient out of the multiple recipients. In an example, regarding the multiple recipients, the output from the machine learning network may indicate a relatively high probability score (e.g., above a threshold) associated with one of the recipients in combination with a relatively high confidence score (e.g., above a threshold) associated with the probability score. For the remaining recipients, the output from the machine learning network may further indicate relatively low probability scores (e.g., below a threshold) in combination with a relatively high confidence scores (e.g., above a threshold) associated with the probability scores.

In some aspects, at 725, the communication device 105 may select a different quantity of recipients based on the output from received from the machine learning network. For example, the communication device 105 may select a single recipient based on the output received from the machine learning network. For example, the communication device 105 may select the recipient associated with the relatively high probability score and the relatively high confidence score.

At 730, the communication device 105 may output, via the user interface of the communication device 105, a notification associated with the message and the single recipient based on the output received from the machine learning network. For example, the communication device 105 may output a notification indicating that the message may be intended for a different (e.g., reduced) quantity of recipients. In an example, the notification may indicate that the message may be intended for the single recipient.

At 735, the communication device 105 may transmit the message to a respective communication device 105 associated with a different quantity of recipients (e.g., a reduced quantity of recipients, the single recipient), based on the output received from the machine learning network. In some examples, the communication device 105 may transmit the message based on the output received from the machine learning network, the notification output by the communication device 105, and/or a user input (e.g., confirming the message and/or different quantity of recipients).

In some aspects, outputting the notification, transmitting the message, or both may be based on a comparison of the set of probability scores (e.g., of the multiple recipients) to a probability threshold, a comparison of the set of confidence scores (e.g., of the multiple recipients) to a threshold, or both. In some cases, the communication device 105 may output the notification, transmit the message, or both based on the verification of the one or more intended recipients (e.g., based on the verification of the single recipient). In some cases, the communication device 105 may output the notification, transmit the message, or both based on the selection of the single recipient.

Alternatively, or additionally, at 715 through 735, the communication device 105 may select a higher quantity of recipients compared to the intended recipients associated with the message (e.g., initial addressees). For example, the communication device 105 may select the higher quantity of recipients based on the output from received from the machine learning network. In an example, the machine learning network may identify that the message is addressed to a single recipient, and the machine learning network may further identify that the content (e.g., contextual information) of the message suggests multiple recipients. In an example, the output from the machine learning network may indicate a relatively high probability score (e.g., above a threshold) associated with one or more additional or alternative recipients in combination with relatively high confidence scores (e.g., above a threshold) associated with the probability scores.

In some aspects, the methods, devices, and systems described herein may be applied to email clients, instant messaging clients, other types of messaging clients, and social media platforms.

Artificial intelligence, including the utilization of machine learning, can be used in various aspects disclosed herein. For example, as discussed, various levels of content can be analyzed and classified, and this can be configurable by artificial intelligence and/or by user preference. Artificial intelligence, as used herein, includes machine learning. Artificial intelligence and/or user preference can configure information that is used to analyze content and identify relationships between content. For example, artificial intelligence and/or user preference can determine which information is compared to content in order to analyze the content. Artificial intelligence and/or user preference may also be used to configure user profile(s), which may be used to determine relevance to a user (e.g., the user associated with the user profile), a communication (e.g., message, social media posting), a messaging window, and/or an application by comparing the content to information contained within the user profile.

Some embodiments utilize natural language processing in the methods and systems disclosed herein. For example, machine learning models can be trained to learn what information is relevant to a user or different users. Machine learning models can have access to resources on a network and access to additional tools to perform the systems and methods disclosed herein.

In certain embodiments, data mining and machine learning tools and techniques will discover information used to determine content and/or contextual information. For example, data mining and machine learning tools and techniques will discover user information, user preferences, relevance of content, levels of relevance, contextual information, key word(s) and/or phrases, thresholds, comparison(s) to threshold(s), configuration(s) of content organization of content, and configuration(s) of a user interface, among other embodiments, to provide improved content analysis and/or contextual analysis.

Machine learning may manage one or more types of information (e.g., user profile information, communication information, etc.), types of content (including portions of content within communication information), comparisons of information, levels of relevance, and organization (including formatting of content). Machine learning may utilize all different types of information. The information can include various types of visual information, documents (including markup languages like Hypertext Markup Language (HTML)), and audio information (e.g., using natural language processing). Inputs and outputs, as described herein, may be managed by machine learning. Machine learning may determine variables associated with information, and compare information (including variables within the information) with thresholds to determine relevance. The relevance may determine content organization based on rules associated with the relevance. Machine learning may manage properties (including formatting, hiding and/or reorganizing) and configurations of the organized content. Any of the information and/or outputs may be modified and act as feedback to the system.

In some aspects, methods and systems disclosed herein use information to analyze content and contextual information. Relevance, and variations thereof, can refer to a determination of how closely a piece of information relates to another piece of information. For example, information may be information that is related to a user, and includes and is not limited to user profile information, association with groups, and information from interactions of the user. Information that is related to a user may be obtained from groups or entities associated with the user. Artificial intelligence and/or user preferences may determine the information that is relevant to a user. For example, artificial intelligence and/or user preference may determine what information is relevant (e.g., appropriate, inappropriate, related) to one or more users, communications, messaging windows, messaging applications, social media applications, etc. Artificial intelligence may use the information to build a profile associated with one or more users, where the profile defines what information (or variables within the information) is relevant to the user, previous communications with the user, current communications generated by the user, and other properties of the relevance (e.g., type of relevance (importance, priority, rank, etc.), level of relevance, etc.). Artificial intelligence and/or user preference may use the profile to compare information with content of a communication to determine relevance between the content (including any differences in relevance of various portions of the content), contacts indicated in the communication, contacts of a user generating the communication, messaging windows associated with the communication, messaging applications associated with the communication, and/or social media applications associated with the communication. Relevance of information is used in various embodiments herein to determine rules for how the content may be extracted and/or analyzed for contextual information.

Relevance, as described herein, includes determining how closely related information is. The determination may be by comparison, and may use any criteria, such as thresholds and/or one or more key words. The information may be content within a communication, where a communication can contain one or more pieces (also referred to herein as portions, sections, or items) of content, and may include content that ranges from being not related at all (e.g., not relevant) to content that is directly related (e.g., highly relevant) to contacts indicated in the communication, contacts of a user generating the communication, messaging windows associated with the communication, messaging applications associated with the communication, and/or social media applications associated with the communication. Portions of content may also be referred to herein as simply “content.” There may be two levels of relevance (e.g., relevant and not relevant), or any number of levels of relevance. Any information may be compared to determine relevance. In various embodiments, user information may be used to determine relevance. The user information may include profile information, such as one or more user profiles, that is compared to content. Various types of relevance may be determined for one or more pieces of information, including relevance, priority, importance, precedence, weight, rank, etc. For example, relevance may determine how related content is to a user, contacts indicated in the communication, contacts of a user generating the communication, messaging windows associated with the communication, messaging applications associated with the communication, and/or social media applications associated with the communication, while priority ranks how important the content is. In various embodiments, priority may be based on how relevant a piece of content is. Any combination of one or more types of relevance may be configured and used. For example, content may have high relevance with a low priority and a low rank, content may have high relevance with a high importance and high rank, content may have low relevance with a high importance and a low priority, etc. Content may have any combinations of types of relevance.

As used herein, information includes communications, messages, electronic records, content, visual content including text and images, audio content, rich media, data, and/or data structures. Communications include emails, messages, documents, files, etc. Information includes content, and communications include content (also referred to herein as data). Content may be one type or multiple types (e.g., text, images, hyperlinks, etc.) and there may be multiple pieces of content within a communication or a piece of information, regardless of content type. Content may contain one or more variables. Communications may be data that is stored on a storage/memory device, and/or transmitted from one communication device to another communication device via a communication network.

Communications include messages. A message may be transmitted via one or more data packets. The formatting of such data packets may be based on the messaging protocol used for transmitting the electronic records over the communication network.

Information related to communications may be referred to herein as communication information, communication data, or communication content, and variations of these terms. Communication information can include any type of data related to communications of a user and/or entity (e.g., information being sent to user(s), received from user(s), created by user(s), accessed by user(s), viewed by user(s), etc.). Content of a communication can include information associated with the communication as well as information contained within the communication. Content of a communication may include information not only that is sent and received, but also other information such as information that a user does not necessarily send or receive. Content of communications may be classified in various ways, such as by a timing of the content, items the content is related to, users the content is related to, key words or other data within fields of the communication (e.g., to field, from field, subject, body, etc.), among other ways of classifying the content. The content may be analyzed based on information associated with the content and/or variable(s), including the location of the content and/or variables as it relates to the communication (e.g., a field, sender, recipient, title, or body location within the communication).

As used herein, a data model may correspond to a data set that is useable in an artificial neural network and that has been trained by one or more data sets that describe communications between two or more entities. The data model may be stored as a model data file or any other data structure that is useable within a neural network or an artificial intelligence system.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Illustrative hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or very large-scale integration (VLSI) design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or Common Gateway Interface (CGI) script, as a resource residing on a server or computer workstation, as a routine embedded in a dedicated measurement system, system component, or the like. The system can also be implemented by physically incorporating the system and/or method into a software and/or hardware system.

Methods described or claimed herein can be performed with traditional executable instruction sets that are finite and operate on a fixed set of inputs to provide one or more defined outputs. Alternatively, or additionally, methods described or claimed herein can be performed using artificial intelligence, machine learning, neural networks, or the like. In other words, a system is contemplated to include finite instruction sets and/or artificial intelligence-based models/neural networks to perform some or all of the steps described herein.

The present disclosure, in various aspects, embodiments, and/or configurations, includes components, methods, processes, systems, and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1. A method comprising:
identifying a message that is input via a user interface of a device;
providing at least a portion of the message to a machine learning network;
receiving an output from the machine learning network in response to the machine learning network processing at least the portion of the message, wherein the output comprises: a set of recipients for the message, probability information corresponding to the message and the set of recipients, confidence information associated with the probability information, or a combination thereof, wherein the output is determined based at least in part on a comparison of a message type of the message and a set of message types included in profile information of one or more contacts, wherein the one or more contacts are associated with a user profile associated with the device; and
outputting a notification associated with the message, transmitting the message to a respective device associated with one or more recipients of the set of recipients, or both based at least in part on the output from the machine learning network.

2. The method of claim 1, wherein the set of recipients includes one or more intended recipients associated with the message, one or more additional recipients different from the one or more intended recipients, or both.

3. The method of claim 2, further comprising:
verifying the one or more intended recipients based at least in part on the output received from the machine learning network,
wherein outputting the notification, transmitting the message, or both is based at least in part on the verification.

4. The method of claim 2, further comprising:
selecting the one or more additional recipients based at least in part on the output received from the machine learning network,
wherein outputting the notification, transmitting the message, or both is based at least in part on the selection of the one or more additional recipients.

5. The method of claim 1, wherein the probability information, the confidence information, or both is determined based at least in part on a comparison of at least the portion of the message to the profile information of the one or more contacts associated with the user profile,
wherein the one or more contacts comprises at least the set of recipients.

6. The method of claim 1, further comprising:
assigning category information to the one or more contacts associated with the user profile,
wherein at least the portion of the message is compared to the profile information of the one or more contacts based at least in part on the category information.

7. The method of claim 1, further comprising:
extracting contextual information associated with content included in at least the portion of the message,
wherein at least the portion of the message is compared to the profile information of the one or more contacts based at least in part on the contextual information.

8. The method of claim 1, further comprising:
building the profile information of the one or more contacts based at least in part on a message type of one or more messages exchanged with the one or more contacts in association with the user profile.

9. The method of claim 1, wherein the probability information corresponding to the message comprises first probability information associated with a first messaging window via which the message is input, second probability information associated with a second messaging window, or both;
the method further comprising:
selecting the first messaging window or the second messaging window based at least in part on the first probability information, the second probability information, or both,
wherein the message is transmitted using the first messaging window or the second messaging window based at least in part on the selection.

10. The method of claim 1, the probability information corresponding to the message comprises first probability information associated with a first application via which the message is input, second probability information associated with a second application, or both;
the method further comprising:
selecting the first application or the second application based at least in part on the first probability information, the second probability information, or both,
wherein the message is transmitted using the first application or the second application based at least in part on the selection.

11. The method of claim 1, wherein:
the probability information comprises a set of probability scores respectively corresponding to the set of recipients; and
the confidence information comprises a set of confidence scores respectively corresponding to the set of probability scores;
wherein outputting the notification, transmitting the message, or both is based at least in part on a comparison of the set of probability scores to a probability threshold, a comparison of the set of confidence scores to a threshold, or both.

12. The method of claim 1, further comprising:
training the machine learning network based at least in part on a communication history associated with the user profile,
wherein the output provided by the machine learning network is based at least in part on the training.

13. The method of claim 1, further comprising:
training the machine learning network based at least in part on a set of actions associated with the user profile,
wherein the output provided by the machine learning network is based at least in part on the training.

14. The method of claim 13, wherein the set of actions are associated with one or more previous messages provided to the machine learning network, one or more previous outputs received from the machine learning network, one or more previously output notifications, one or more previously transmitted messages, or a combination thereof.

15. The method of claim 1, wherein the message comprises text, multimedia data, or both.

16. A device comprising:
a processor; and
memory in electronic communication with the processor; and
instructions stored in the memory, the instructions being executable by the processor to:
identify a message that is input via a user interface of the device;
provide at least a portion of the message to a machine learning network;
receive an output from the machine learning network in response to the machine learning network processing at least the portion of the message, wherein the output comprises: a set of recipients for the message, probability information corresponding to the message and the set of recipients, confidence information associated with the probability information, or a combination thereof, wherein the output is determined based at least in part on a comparison of a message type of the message and a set of message types included in profile information of one or more contacts, wherein the one or more contacts are associated with a user profile associated with the device; and
output, via the user interface of the device, a notification associated with the message, transmit the message to a respective device associated with one or more recipients of the set of recipients, or both based at least in part on the output received from the machine learning network.

17. The device of claim 16, wherein the set of recipients includes one or more intended recipients associated with the message, one or more additional recipients different from the one or more intended recipients, or both.

18. The device of claim 17, wherein the instructions are further executable by the processor to:
verify the one or more intended recipients based at least in part on the output received from the machine learning network,
wherein outputting the notification, transmitting the message, or both is based at least in part on the verification.

19. The device of claim 17, wherein the instructions are further executable by the processor to:
select the one or more additional recipients based at least in part on the output received from the machine learning network,
wherein outputting the notification, transmitting the message, or both is based at least in part on the selection of the one or more additional recipients.

20. An apparatus comprising:
means for identifying a message that is input via a user interface of the apparatus;
means for providing at least a portion of the message to a machine learning network;
means for receiving an output from the machine learning network in response to the machine learning network processing at least the portion of the message, wherein the output comprises: a set of recipients for the message, probability information corresponding to the message and the set of recipients, confidence information associated with the probability information, or a combination thereof, wherein the output is determined based at least in part on a comparison of a message type of the message and a set of message types included in profile information of one or more contacts, wherein the one or more contacts are associated with a user profile associated with the apparatus; and
means for outputting a notification associated with the message, transmitting the message to a respective device associated with one or more recipients of the set of recipients, or both based at least in part on the output received from the machine learning network.
